(19) United States
(12) Patent Application Publication
(10) Pub. No.: US 2013/0275052 A1
(43) Pub. Date: Oct. 17, 2013

(54) METHOD AND DEVICE OF DETERMINING A CO2 CONTENT IN A LIQUID

(71) Applicant: ANTON PAAR GMBH, (US)

(72) Inventors: Johann LODER, Weiz (AT); Roman BENES, Graz (AT); Michael IMRE, Graz (AT)

(73) Assignee: ANTON PAAR GMBH, Graz-Strassgang (AT)

(21) Appl. No.: 13/771,543

(22) Filed: Feb. 20, 2013

(30) Foreign Application Priority Data
Feb. 20, 2012 (AT) A 211/2012

(51) Int. Cl. G01N 21/59

(52) U.S. Cl. CPC G01N 21/59
USPC 702/24

(57) ABSTRACT

The CO₂ content in a liquid, in particular a beverage, is to be tested. Three absorption measurements of the liquid are carried out respectively at a wavelength within a first wavelength range between 4200 and 4300 nm to measure a first absorption value with attenuated total reflectance, at a second wavelength within a second wavelength range between 3950 and 4050 nm and a second absorption value with attenuated total reflectance, and at a third wavelength within a third wavelength range between 3300 and 3900 nm and a third absorption value with attenuated total reflectance. A pre-defined model function is used for determining the CO₂ content based on the first, second and third absorption values. The model function is applied to the absorption values and the result of the evaluation is kept available as the CO₂ content of the liquid to be tested.

The invention relates to a method of determining the CO₂ content in a liquid to be tested according to the preamble of independent claim 1. This invention further relates to a device for determining the CO₂ content in a liquid to be tested according to independent claim 7. Methods and devices of the invention for determining the CO₂ content will be advantageously employed in the quality control of beverages.

However, the area of use of the invention is not limited to the quality control of beverages. The exact knowledge of the dissolved ingredients or components of a liquid to be tested, and its respective content in said liquid are required in many production areas, such as biotechnology, in evaluating blood and urine, etc. Components of interest include, for example, carbon dioxide, methanol, ethanol, methane and other chemical substances that are contained in the liquid, for example, in an aqueous solution. An essential requirement of quality control is mainly that the processes should be able to be controlled in real time. Measurements therefor should be done in close association with production, preferably inline, and be able to be conducted in a rough environment.

A plurality of methods of determining the concentration of ingredients in liquids is known in the art, and will be set out in parts below.

Chemically reactive substances are often detected via secondary effects such as a reaction with acids or luminescence quenching. Such methods are not available with chemically inactive substances like CO₂. A possibility of determining the content of chemically inactive gases is separation of the dissolved gas to be measured by gas emission into a measurement space separated by a permeable membrane and then infra-red measurement of the gas, as disclosed in patent specification EP 1 630 543, for example. Suitability of such variations, however, is limited in real-time applications, while their use in an inline method of measuring can be realized at great expense.

In addition, various physical verification procedures are commonly used to determine CO₂ contents, such as methods of manometry. It is mainly in the brewing industry that the volume expansion methods finds use, which allows simultaneous measurement of multiple different dissolved gases based on pressure and temperature values measured. This method is exemplified in patent specification AT 409 673.

Another method is based on the evaluation of absorption and transmission spectra, in which the excitation of characteristic molecular vibrations, i.e. rotations and/or vibrations, within the liquid results in energy absorption and thus change of intensity in the excitation spectrum. Ingredients of low and very low concentrations can be determined by this method, where the concentration of each ingredient in solid, liquid or gaseous media is determined from the absorbance of infra-red radiation. Depending on the measurement task different wavelength areas of the spectrum are used for structure determination, and the measurement area ranges from UV/VIS to the infra-red area. Based on the absorption of radiation of particular energy, the excited molecular or lattice vibrations and thus the components of the assayed material can be concluded. Substances sufficiently transmissible for measurement radiation can be measured in transmission, for opaque solids and intensely colored solutions evaluating reflections, such as by the method of attenuated total reflectance (ATR), is known. In process analytics, applicability of transmission measurements is often limited due to the strong absorption by water molecules within the infra-red area, such that reflection measurements like the ATR method are used advantageously. Spectroscopic determination has the other advantage that the measurement results are independent of the pressure of the tested liquid and its components.

The examined infra-red spectra can thus be used for structure determination, and if the composition of the tested liquid is known, the concentration of the tested components in the liquid can also be determined. If the tested liquids have absorption values too high to obtain a utilisable signal, the principle of attenuated total reflectance (ATR) is often employed. There are multiple eligible absorption bands in the infra-red area that can be ascribed to the CO₂ vibrations. Dissolved CO₂, for example, has a characteristic absorption band in the area around 4.3 μm, which is largely independent of the components commonly present in the beverage samples usually tested.

The method of ATR, also known under the designation multiple internal reflection, has been used for analysis purposes for many years. In ATR spectroscopy, the effect of a light beam being totally reflected at the interface between an optically thicker medium having a refractive index n₁ and an optically thinner medium having a refractive index n₂ (with n₁>n₂), when the incident angle of the light beam towards the interface exceeds the critical angle θ of total reflection, is used. For the critical angle θ, sin(θ)=n₂/n₁. At the interface, the light beam enters, and interacts with, the optically thinner medium. A so-called evanescent wave with a penetration depth dₚ in the magnitude of the wavelength λ is formed behind the reflecting surface. The penetration depth dₚ is dependent on the two refractive indices n₁ and n₂, the wavelength λ that is used and the incident angle θ.

$${d}_{p} = \frac{λ}{2 \cdot π \cdot \sqrt{{n}_{1}^{2} \cdot {sin}^{2} ( θ ) - {n}_{2}^{2}}}$$

When the optically thinner medium absorbs the penetrating radiation, the totally reflected beam is attenuated. Absorption is thus dependent on the wavelength λ and the spectrum of the totally reflected radiation can be used for spectroscopy evaluation in analogy to transmission measurements. Based on the transmission or extinction spectrum, the composition of the optically thinner medium can be concluded.

It is well known to use absorption spectra for the purposes of detecting ingredients in liquids and characterising liquid mixes, in which ingredients can be detected and quantified even at very low concentrations. This is done by exploiting the fact that molecules are set into vibration by infra-red radiation of selected wavelength, e.g. dissolved CO₂ has a characteristic absorption band in the area around 4.3 μm. Absorption can be converted to accurate concentration measurements by means of the Beer-Lambert law. This law describes:

$${E}_{λ} = - lg ( \frac{I}{{I}_{0}} ) = {ɛ}_{λ} \cdot c \cdot d ,$$

where E_{λ} represents extinction, I represents the intensity of the transmitted light, I₀ represents the intensity of the incident light, ε_{λ} represents is extinction coefficient, c represents the concentration of dissolved CO₂, and d represents the length of path of the body or the fluid medium penetrated by radiation.

The core component of the ATR sensor is an ATR reflection element, which is transparent in the area of interest for measurement radiation and has a high refractive index. Known materials for ATR reflection elements include, for example, sapphire, ZnSe, Ge, Si, thallium bromide, YAG (yttrium aluminium garnet, Y₂Al₅O₂₂), spinel (MgAl₂O₄), etc. These reflection elements are often carried out such that the interaction length at the interface to the liquid is increased by multiple reflection. Other elements include one or more radiation sources of appropriate frequency (ranges), optionally with means of selecting a frequency, and one or more detectors, which can also be carried out in a frequency-selective manner.

In its most simple form, an ATR sensor comprises an ATR reflection element that allows internal reflections, a radiation source and a detecting unit. The ATR reflection element protrudes into a liquid to be tested either directly into the process stream or into the substance to be tested in a container. Often, a second frequency is evaluated in order to reference to the absorption of the solvent. This is either done by appropriate means of frequency selection (such as variable filters) or by separate filter areas on the detector or by a second source/detector arrangement on the same ATR reflection element. The reflection element is tightly pressed against the housing and attached in a hermetically sealed manner, wherein various sealing materials are used depending on the chemical resistance and compressive strength required.

It is known in the art that for process monitoring, such optical measurement systems are individually adapted to the liquids to be tested. The actual absorption values determined in the ATR sensor will be converted to concentrations by selecting a calibration model adapted to each individual liquid, while a plurality of known factors that affect the measurement are taken into consideration at calibration. Based on calibration curves measured for known compositions, the measured absorption values are converted to actual concentration values according to the laws described above.

According to the Beer-Lambert law, the actual absorbed intensity is dependent on the wavelength-dependent extinction coefficient as well as the concentration c of the absorbing component and the length of path d of the body penetrated by radiation. In ATR geometry, the length of path of the tested solution is determined by the penetration depth dₚ of the evanescent wave. According to the laws of total reflectance, it depends on the refractive index of the reflection element as well as each individual liquid, how far the wave penetrates the optically thinner medium.

The refractive index of the solution plays a role in the CO₂ determination of beverages in that the penetration depth of the ATR beam and thus the absorption of the beam are highly dependent on the ratio between the refractive index of the ATR reflection element and the liquid to be tested. Most of the time, this refractive index of the liquid to be tested is primarily determined by the sugar, extract and/or alcohol contents of the liquid, so that the type of liquid itself is of essential influence to the absorption of the ATR beam.

Based on the various refractive indices of liquids to be evaluated and the absorption resulting therefrom there is the problem of different calibration models having to be found for different liquids, in order for a determination of the CO₂ content to be possible. A separate calibration model would have to be found for each individual liquid.

If, for example, a bottling plant for a variety of liquids is used, this would bring about the problem that a calibration would have to take place every time the liquid to be bottled is changed, or at least the appropriate calibration model would have to be set up manually. This can entail further problems particularly during quick changes between individual liquids or in very large plants with many liquids to be bottled at the same time, especially when the respective liquid is chosen incorrectly.

The object of the invention is thus to overcome the problems mentioned above and to determine the CO₂ concentration independent of a pre-set calibration model individually adjusted to each individual liquid and thereby to avoid error-prone pre-selection of the respective liquid. Measurement and evaluation of the measurement values should therefore be performed independent of any pre-selection of liquids, and false influences due to incorrect choice of models and/or changing product compositions should be avoided.

The invention solves this task in a method of the above kind having the characteristic features of claim 1.

According to the invention, in a method of determining the CO₂ content in a liquid to be tested, in particular a beverage, wherein measurement of the absorption of the liquid to be measured is performed at minimum one wavelength within a first wavelength range between 4200 and 4300 nm and a first absorption value is measured using the method of attenuated total reflectance, wherein the measurement of the absorption of the liquid to be measured is performed at minimum one second wavelength within a second wavelength range between 3950 and 4050 nm and a second absorption value is measured using the method of attenuated total reflectance, it is intended that the measurement of the absorption of the liquid to be measured is additionally performed at minimum one third wavelength within a third wavelength range between 3300 and 3900 nm and that a third absorption value is measured using the method of attenuated total reflectance, that a predetermined model function is used for determining the CO₂ content based on the first, second and third absorption values and that the model function is applied to the determined first, second and third absorption values and the result of the evaluation is kept available as the CO₂ content of the liquid to be tested.

Thanks to this procedure it is no longer required to perform a separate calibration for each liquid to be tested, neither is it longer required to perform adjustments of the calibration model or to change the calibration model itself whenever the type of liquid to be tested is changed.

For numerically stable determination of the CO₂ content and for straightforward determination of each absorption, it can be intended that the measurement of the first absorption value by determining the absorbed intensity is performed in a first measurement area, which is defined by a first spectral centroid and a first area width 2Δλ_{CO2}, in which the first measurement area is in the range of λ_{S,CO2}±Δλ_{CO2}, and/or that the measurement of the second absorption value by determining the absorbed intensity is performed in a second measurement area, which is defined by a second spectral centroid and a second area width 2Δλ_{ref}, in which the second measurement area is in the range of λ_{S,ref}±Δλ_{ref}, and/or that the measurement of the third absorption value by determining the absorbed intensity is performed in a third measurement area, which is defined by a third spectral centroid and a third area width 2Δλₙ, in which the third measurement area is in the range of λ_{S,n}±Δλₙ, in which the first and/or second and/or third area widths are each within a range between 20 nm and 200 nm, in particular at 100 nm.

Alternatively, it can, for the same purpose, be intended that the first absorption value is, preferably exclusively, determined at a predefined wavelength within the first wavelength range, preferably 4260 nm, and/or that the second absorption value is, preferably exclusively, determined at a predefined wavelength within the second wavelength range, preferably 4020 nm, and/or that the third absorption value is, preferably exclusively, determined at a predefined wavelength within the third wavelength range, preferably 3800 nm.

In order to be able to better take the influence of temperature on absorption into consideration, it can be intended that the temperature of the liquid to be tested is determined in addition to determining the first, second and third absorption values, that the model function for determining the CO₂ content takes the temperature of the liquid to be tested into consideration in addition to the first, second and third absorption values and that the model function is applied to the first, second and third absorption values that have been determined and also to the temperature that has been determined and the result of the evaluation is kept available as the CO₂ content of the liquid to be tested.

For calibration and for determining a preferable model function it can be intended that prior to determining the CO₂ content a model function is created, and kept available for determining the CO₂ content, by conducting a plurality of reference measurements of the first, second and third absorption values each for different reference liquids with known CO₂ contents and different, optionally known, refractive indices, creating the model function having the following formula:

M=M(A_{CO2},A_{ref},Aₙ, . . . ,B₁, . . . ,B_{N})

using a fitting method, in which previously unknown model parameters are each adjusted to the given CO₂ content and to the first, second and third absorption values, so that the known CO₂ content is obtained, or at least approximated, when the model function is applied to the first, second and third absorption values.

In order to be able to take the influences of temperature into consideration, it can be intended that, in addition to the first, second and third absorption values, the temperature of each respective reference liquid is determined in the plurality of reference measurements, that the model function having the following formula:

M=M(A_{CO2},A_{ref},Aₙ,T, . . . ,C₁, . . . ,C_{N})

is created using a fitting method in which previously unknown model parameters are each adjusted to the given CO₂ content, to the first, second and third absorption values and to the respective temperature, so that the known CO₂ content is obtained, or at least approximated, when the model function is applied to the first, second and third absorption values as well as the temperature.

The invention solves this task using a method of the above kind having the characteristic features according to claim 7.

According to the invention, in a device for determining the CO₂ content in a liquid to be tested comprising a first ATR measurement unit for determining a first absorption value at minimum one first wavelength within a first wavelength range between 4200 and 4300 nm and a second ATR measurement unit for determining a second absorption value at minimum one second wavelength within a second wavelength range between 3950 and 4050 nm, the following is provided:
a third ATR measurement unit for determining a third absorption value at minimum one third wavelength within a third wavelength range between 3300 and 3900 nm; and
an evaluation unit downstream of the ATR measurement units, to which the results of the ATR measurement units are transferred, wherein the evaluation unit applies a model function to the first, second and third absorption values and the result of the evaluation is kept available at its outlet as the CO₂ content of the liquid to be tested.

For numerically stable determination of the CO₂ content it can be intended that the ATR measurement units for determining the absorbed intensity are sensitive in a first, a second and a third measurement area, in which the first measurement area is defined by a first spectral centroid within the first wavelength range and a first area width 2Δλ_{CO2} and the first measurement area is determined to be in the range of λ_{S,CO2}±Δλ_{CO2}, and/or in which the second measurement area is defined by a second spectral centroid within the second wavelength range and a second area width 2Δλ_{ref} and the second measurement area is determined to be in the range of λ_{S,ref}±Δλ_{ref}, and/or in which the third measurement area is defined by a third spectral centroid within third first wavelength range and a third area width 2Δλₙ and the third measurement area is determined to be in the range of λ_{S,n}±Δλₙ, in which the first and/or second and/or third area widths are each within a range between 20 nm and 200 nm, in particular at 100 nm.

In order to better take the influences of temperature on absorption and thus on the determined CO₂ content into consideration, a temperature sensor upstream of the evaluation unit can be provided for determining the temperature of the liquid to be tested, in which the evaluation unit applies a model function to the first, second and third absorption values and the temperature determined by the temperature sensor, and the result of the evaluation is kept available at its outlet as the CO₂ content of the liquid to be tested.

For advantageous storage or conveyance of the liquid to be tested during quality control a container for storing or conveying the liquid to be tested can be provided, in which the sensitive surface parts of the ATR measurement units and optionally the temperature sensor come into contact with the liquid to be tested when filled into, or passing through, the container holding the same and are specifically arranged on the inside of the vessel.

In order to be able to quickly call up the calibration model and apply it to the determined measurement values, it can be intended that memories for predefined coefficients are provided within the evaluation unit and that the evaluation unit has a calculation unit, to which the stored coefficients as well as the first, second and third absorption values, and optionally also the determined temperature, are supplied and which evaluates the model function based on the values it was supplied with and keeps it available at the outlet of the evaluation unit.

Advantageous space-saving advancements of the invention involve each ATR measurement unit comprising an ATR reflection element, an ATR infra-red source and an ATR infra-red sensor or all ATR measurement units sharing a mutual ATR reflection element and a mutual ATR infra-red source active within the first, second and third wavelength ranges as well as a mutual ATR infra-red sensor active within the first, second and third wavelength ranges, in which in the optical path between the ATR infra-red source and the ATR infra-red sensor an adjustable filter, in particular a filter wheel or a Fabry-Pérot interferometer, is provided, which, depending on its set-up, is transmissive only for radiation within the first, the second or the third wavelength range, or the ATR measurement units sharing a mutual ATR reflection element and a mutual ATR infra-red source active within the first, second and third wavelength ranges and separate ATR infra-red sensors being provided for the first, second and third wavelength ranges, each located at the end of the respective optical path, or the ATR measurement units sharing a mutual ATR reflection element and a mutual ATRinfra-red sensor sensitive for the first, second and third wavelength ranges and separate ATR infra-red sources being provided for the first, second and third wavelength ranges.

A space-saving embodiment of the invention with a single reflection element involves the ATR measurement units having at least two separate ATR infra-red sources and corresponding ATR infra-red sensors that each have independent optical paths and different sensitivities, in which it is always one measurement unit of the first infra-red sensor and one measurement unit of the second infra-red sensor that are sensitive for the same wavelength range, and a referencing unit being provided that multiplies the measurement value of the third measurement unit by the ratio between the measurement values of the two measurement units sensitive for the same wavelength range, keeping it available at its outlet.

The invention is now exemplified based on a specific exemplary embodiment by means of the following drawings:

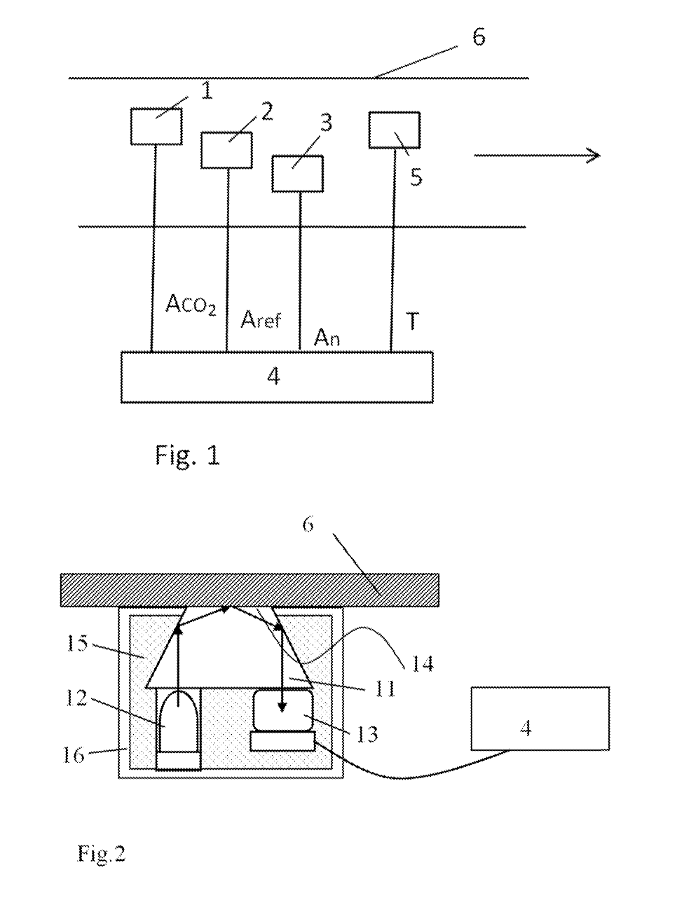

FIG. 1 shows an embodiment of a device according to the invention.

FIG. 2 shows the design of an ATR sensor in detail.

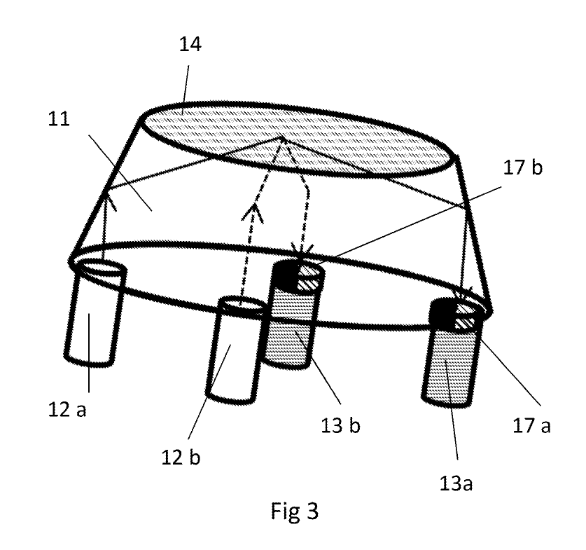

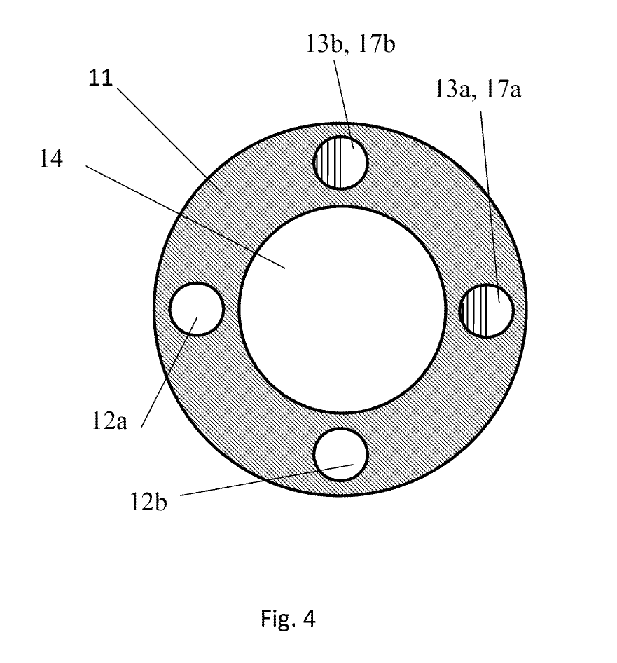

FIG. 3 shows a preferred ATR sensor in an oblique view.

FIG. 4 shows the ATR sensor of FIG. 3 in front view.

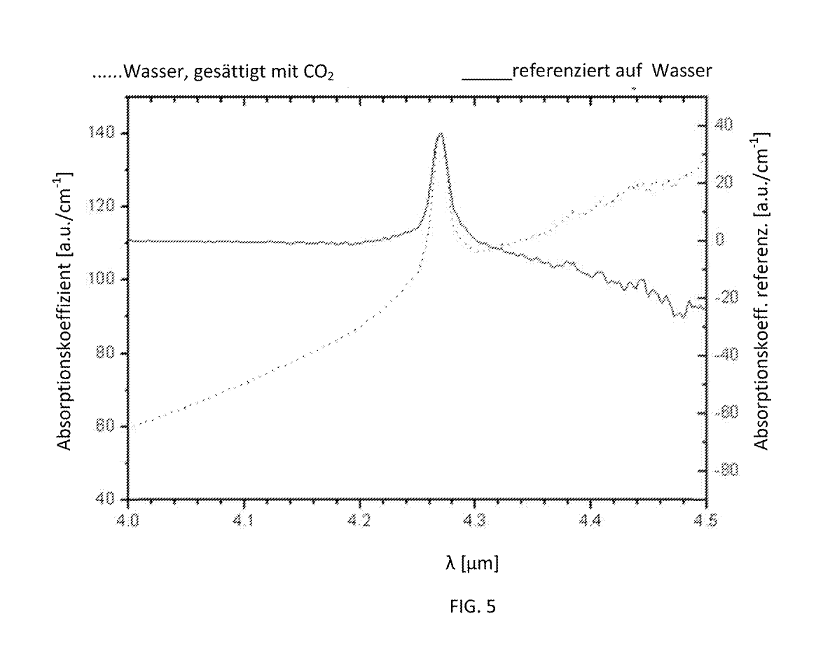

FIG. 5 shows the spectrum of a liquid to be tested.

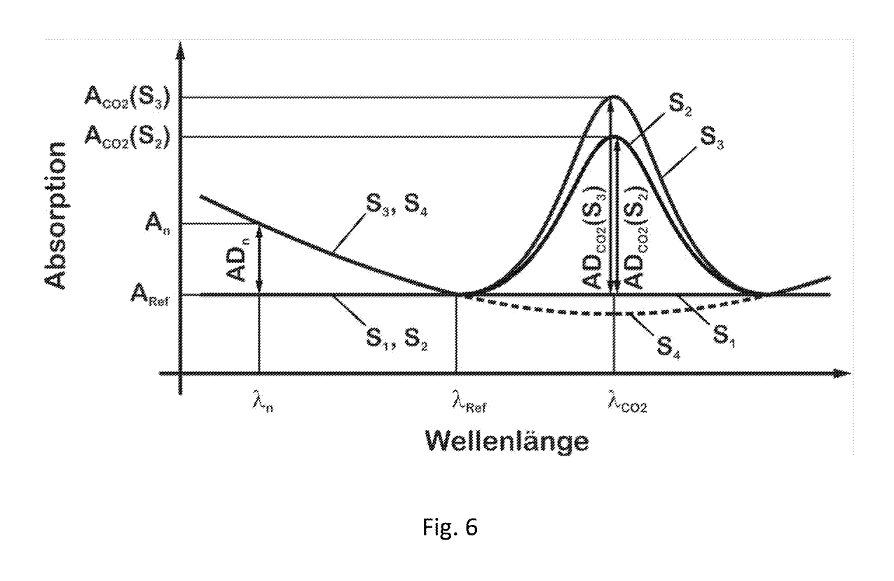

FIG. 6 is a schematic representation of liquids to be tested, each having different CO₂ contents and different refractive indices, with reference to the solvent.

In the present embodiment of the invention shown in FIG. 1, the liquid to be tested is passed through a container 6 in the form of a conduit. Three separate ATR measurement units 1, 2, 3 as well as a temperature sensor 5 are arranged on the interior surface of the conduit. The sensitive surface parts 14 (see FIG. 2) of the ATR measurement units 1, 2, 3 are in contact with the liquid that is passed through the conduit. The temperature sensor 5 is located on the inside of the conduit or on the limiting wall contacting the liquid. The measurement values of the temperature sensor 5 and the ATR measurement units 1, 2, 3 are supplied to an evaluation unit 4.

FIG. 2 shows an ATR measurement unit 1, 2, 3 in detail. The core component of the ATR measurement unit 1, 2, 3 is a reflection element 11 that is transparent for radiation within the wavelength range of interest and has a high refractive index.

These elements can include a prism, a special ATR crystal, an optical fibre, etc. Known materials for such optical elements include, for example, sapphire, ZnSe, Ge, Si, thallium bromide, YAG and spinel, etc. The reflection elements 11 are often carried out in a way that the intensity yield in their interior is increased through multiple reflections. The ATR measurement unit 1, 2, 3 further comprises a radiation source 12 within the individual frequency range and a detector 13. A measurement signal is read out at the outlet of each detector 13 which corresponds to the intensity determined by the detector 13. Any frequency-selective means in the optical path between the source and the detector define the measurement wavelength λ and the measurement range λₛ±Δλ at the spectral centroid λ_{S} of the ATR measurement unit.

In the present exemplary embodiment, each of the ATR measurement units 1, 2, 3 is surrounded by a housing 16, which defines a housing interior 15, in which the reflection element 11, the radiation source 12 and the detector 13 are arranged. The sensitive surface part 14 of the reflection element 11 continues the exterior wall of the housing 16 relative to the liquid to be tested and contacts the same. The reflection element 11 is pressed tightly against, or in pressure- or gas-tight connection with, the housing 16, for example, via an O-ring or via soldered connection, or else via inelastic seals made, for example, of PEEK or TEFLON.

Alternatively, the individual ATR measurement units 1, 2, 3 can be integrated in a common housing 16 and share a mutual reflection element 11 and in particular a mutual radiation source 12 or a mutual detector 13. In this case, the embodiments set out below have proven useful:

In a first alternative, the ATR measurement units 1, 2, 3 share a mutual ATR reflection element 11 and a mutual ATR infra-red source active in the first, second and third wavelength ranges. Also the ATR measurement units 1, 2, 3 share a mutual ATR infra-red sensor active in the first, second and third wavelength ranges. In the optical path between the infra-red source 11 and the infra-red sensor 12, an adjustable filter with adjustable filter characteristics is provided. Said filter is preferably designed in the shape of a filter wheel which has filters with varying filter characteristics in various regions of its perimeter. The filter wheel is rotated by a motor, so that depending on the adjustment of the filter wheel, the predetermined perimeter area with its specific filter characteristics comes into the optical path. Each perimeter area has a filter that is transmissible either within the first, the second or the third wavelength range only, so that depending on the adjustment of the filter, the ATR measurement unit 1, 2, 3 performs measurements of absorption in the first, the second or the third wavelength range, respectively. A filter of this kind can also be designed like a Fabry-Pérot interferometer.

In a second alternative, the ATR measurement units 1, 2, 3 share a mutual reflection element 11 and a mutual infra-red source 12 active in the first, second and third wavelength ranges. Infra-red sensors 13 are provided at the end of the corresponding optical path for each of the first, second and third wavelength ranges.

In a third alternative, the ATR measurement units 1, 2, 3 share a mutual reflection element 11 and a mutual infra-red sensor 13 sensitive for all wavelength ranges, in which separate infra-red sources 12 are provided for each of the first, second and third wavelength ranges.

Another alternative are combinations of the above designs. For example, each ATR reflection element can be equipped with 2 detectors and sources at 2 different wavelength ranges, each using a shared filter for additionally measuring another frequency, such as a reference frequency. This way, differing intensities can be normalised with respect to each other even if the source varies.

The respective measurement signals of the measurement units 1, 2, 3 and the temperature value T found at the outlet of the temperature measurement unit 5 are transferred to the evaluation unit 4, which, as described below, calculates a value for CO₂ concentration and keeps it available at its outlet for further use. This value for CO₂ concentration can be used for adjusting the desired concentration by adjusting the CO₂ supply to the process. The value for CO₂ concentration can also be used to redirect and sort out, or redirect back into the production process, parts of the liquid having too high or too low CO₂ concentrations.

FIG. 3 shows a preferred embodiment of an ATR sensor with four measurement units 1, 2a, 2b, 3, by which three absorption values A_{CO2}, A_{ref}, Aₙ can be determined. In this particular embodiment, only a single reflection element 11, but two infra-red sources 12 are provided, the first of which, infra-red source 12a, emits infra-red light at the first and second wavelength ranges while the second one, infra-red source 12b, emits infra-red light at the second and third wavelength ranges. In addition, two infra-red sensors 13 are provided, the first of which, infra-red sensor 13a, is sensitive within the area of the first and the area of the second wavelength ranges and provides a first absorption value A_{CO2} in the first and a second absorption value A_{ref} in the second wavelength range. The second infra-red sensor 13b is sensitive within the area of the second and the area of the third wavelength ranges and provides a second absorption value A_{ref} in the second and a third absorption value Aₙ in the third wavelength range. The first infra-red sensor 13a and the first infra-red source 12a are arranged such that the light of the first infra-red source 12a irradiates the first infra-red sensor 13a. The second infra-red sensor 13b and the second infra-red source 12b are arranged such that the light of the second infra-red source 12b irradiates the second infra-red sensor 13b. The optical paths of the light beams emitted by the infra-red sensors 12a, 12b are normal to each other in the present exemplary embodiment, as shown in FIG. 4. Preferably, the measurement ranges of the two filters 17a and 17b are separated. Both allow determination of two of absorption values Aₙ, A_{ref}, A_{CO2} in the respective measurement areas λ_{S,ref}±Δλ_{ref}, A_{S,CO2}±Δλ_{CO2} and A_{S,n}±Δλₙ.

In the present exemplary embodiment, both infra-red sensors 13a, 13b each determine a second absorption value A_{ref}. In order to balance variations in brightness between infra-red sources 12a, 12b with respect to each other, the ratio between the second absorption value determined by the first infra-red sensor 13a and the second absorption value determined by the second infra-red sensor 13b is calculated. When multiplying the second absorption value determined by the second infra-red sensor 13b by the calculated ratio, the second absorption value determined by the first infra-red sensor 13a is obtained. In order to prevent varying illumination intensities by the two infra-red sources 12, 12b from influencing the ratio the individual absorption values have to each other, the third absorption value determined by the second infra-red sensor 13b is multiplied by the calculated ratio and taken as a basis for further calculations.

FIG. 5 shows a typical spectrum of absorption coefficients for the saturated aqueous CO₂ solution. It can be clearly seen how the absorption in the area of about 4260 nm increases considerably, while CO₂-free water does not exhibit any increase of absorption in this wavelength range.

FIG. 6 is a schematic representation of absorption spectra of four different liquids. The individual effects of CO₂ and a substance, in the present case: sugar, which is dissolved in the respective liquid at a concentration of c_{extract} and elevates the refractive index, on the absorption spectrum of an ATR measurement are briefly shown. Absorption spectra of the following liquids are presented:

TABLE 1
CO₂ concentration and BRIX of liquids, the absorption
spectra of which are depicted in FIG. 6.

| | CO₂ [g/l] | C_{extract} [BRIX] |
|---|---|---|
| S₁ | 0 | 0 |
| S₂ | 5 | 0 |
| S₃ | 5 | 10 |
| S₄ | 0 | 10 |

The absorption spectrum S₁ of a first liquid has a BRIX value of 0 and is free of CO₂, is near constant within a wavelength range between 3000 nm and 4500 nm and has, especially in relation to the water background, no marked increases, maxima, minima, etc.

A second absorption spectrum S₂ was created for a second liquid, which does not contain sugar and has a BRIX value of 0 and a content of 5 g/l CO₂. The absorption spectrum S₂ of the second liquid exhibits a clear peak at a wavelength λ_{CO2} of about 4260 nm. Beneath a wavelength λ_{ref} of about 4050 nm, the absorption spectrum S₂ of the second liquid is equal to the absorption spectrum S₁ of the first liquid.

A third absorption spectrum S₃ was created for a third liquid, which contains sugar and has a BRIX value of 10 and also a content of 5 g/l CO₂. In a wavelength range above a wavelength λ_{ref} of about 4050 nm, the third absorption spectrum S₃ has a similar course as the second absorption spectrum S₂, with the peak also being within the area of a wavelength λ_{CO2} of about 4260 nm but being more distinct as in the case of the second absorption spectrum S₂, i.e. the absorption being stronger than with the second absorption spectrum S₂. Beneath a wavelength λ_{ref} of about 4050 nm, the absorption increases relative to the first two absorption spectra S₁, S₂ with decreasing wavelengths. At a wavelength λₙ of about 3800 nm, a clear deviation can already be observed between the second and third liquids based on the absorption of the extract.

The fourth absorption spectrum S₄ was created for a fourth liquid, which contains sugar and has a BRIX value of 10 but does not contain CO₂ as opposed to the third liquid. In an area above a wavelength λ_{ref} of about 4050 nm up to a wavelength range at about 5000 nm, the absorption spectrum S₄ has an approximately parabolic curve. In an area below a wavelength λ_{ref} of about 4050 nm down to a wavelength range at about 3000 nm, the absorption spectrum S₄ of the fourth liquid approximately matches the absorption spectrum S₃ of the third liquid.

As can be seen from the depicted absorption spectra S₁, S₂, S₃, S₄, both the change of the refractive index of each respective liquid and a change in the CO₂ content of each respective liquid have effects on the respective absorption spectrum S₁, S₂, S₃, S₄ and measurement alone at the wavelength of maximum absorption λ_{CO2} or the wavelength of λ_{ref} does not allow definitely determining the CO₂ content, as the influence of the refractive index on the respective absorption spectrum leads to distortions of the result. However, it can be concluded from the absorption spectra S₃, S₄ of the third and fourth liquids that the influence of the respective refractive index can be corrected by determining an additional absorption value at a wavelength λₙ in the range of 3300 nm to 3900 nm.

Preferred is measurement of the absorption value with a wavelength limitation as clear as possible. The first absorption value λ_{CO2} is determined at a predefined first wavelength λ_{CO2} (preferably at 4260 nm) within the first wavelength range. The second absorption value A_{ref} is determined at a predefined second wavelength λ_{ref} (preferably at 4020 nm) within the second wavelength range. The third absorption value Aₙ is determined at a predefined third wavelength λₙ (preferably at 3800 nm) within the third wavelength range.

The wavelength-selective means used in the ATR sensors actually have finite half-widths. Thus, spectral resolution, as in spectrometers, for example, cannot be achieved. As a consequence, the absorption values measured at the detector always match the integrated intensity over a wavelength range, which is characterised by the characteristics of the sensor. The absorption is hence determined with a certain spectral width ±Δλ around the spectral centroid λ of the sensor.

In order to be able to carry out an appropriate correction, it is not required to determine absorption at specific fixed wavelengths, it is sufficient if the spectral centroid of a respective sensor is within the respective wavelength range, i.e. if the first spectral centroid λ_{CO2} is within a wavelength range between 4200 and 4300 nm, the second spectral centroid λ_{ref} is within a wavelength range between 3950 nm and 4050 nm and the third spectral centroid Aₙ is within a wavelength range between 3300 and 3900 nm.

Each of the absorption values, A_{CO2}, A_{ref} and Aₙ is determined by measuring the integral absorbed intensity within the wavelength range ±Δλ around the respective spectral centroids λ_{CO2}, λ_{ref}, λₙ. Preferably, the spectral width Δλ around the spectral centroid λ is smaller than ±50 nm.

Preferably the individual wavelength within the predefined first, second and third wavelength ranges will be chosen such that a sufficient signal/noise ratio is to be expected for the respective remnants in the solution.

Four exemplary embodiments of how a value c_{CO2} for the CO₂ concentration is determined based on the measured values for the first, second and third absorption values A_{CO2}, A_{ref}, Aₙ as well as for the temperature T will now be described. In the evaluation unit 4, to which the individual absorption values A_{CO2}, A_{ref}, Aₙ and a value for the temperature T are supplied, the value c_{CO2} for the CO₂ concentration is determined using a model function M.

All exemplary embodiments use formulations in which the three absorption values A_{CO2}, A_{ref}, Aₙ are each replaced with the two differential values ADₙ, AD_{CO2}. The second absorption value A_{ref} is used a reference value at the second wavelength λ_{ref}, and for further calculations, only the differences from this reference value will be used:

ADₙ=Aₙ−A_{ref},AD_{CO2}=A_{CO2}−A_{ref}.

In general, a model function M is defined, which defines the CO₂ concentration depending on the two differential values and the temperature T.

c_{CO2}=M(AD_{CO2},ADₙ,T).

As an alternative to the two differential values AD_{D}, AD_{CO2}, the actual absorption values A_{ref}, Aₙ, A_{CO2} can be used. The model function will then have the following form:

c_{CO2}=M(A_{CO2},Aₙ,A_{ref},T).

Depending on which accuracy class is desired, more or fewer terms can be taken into consideration in the respective approximation, with the model function always being defined by a number of calibration constants. Different model functions, such as a Taylor series development, can be used for modelling interconnections and interdependencies.

Based on observations in FIG. 6, the effects of different influences on the measured absorption value A_{CO2} and on the first differential value AD_{CO2} are illustrated. The measured absorption value A_{CO2} is dependent on the temperature T, the CO₂ content c_{CO2} and the refractive index. In individual exemplary embodiments the below basic assumptions will be made in order to take these interdependencies into mathematical consideration. A modelling of this connection can generally be carried out as follows:

AD_{CO2}˜T: For the connection between the measured absorption value CO₂ and the temperature T, a linear approach is used.

AD_{CO2}˜c_{CO2}: For the connection between the first differential value AD_{CO2} and the CO₂ content, different assumptions can be made; in particular, a linear, a polynomial or an exponential approach can be used.

AD_{CO2}˜n, ADₙ, Aₙ: In order to consider the influence of the refractive index n or the third absorption value Aₙ or the second differential value ADₙ on the first absorption value AD_{CO2}, a polynomial approach is preferably chosen.

In the first exemplary embodiment, the temperature T of the liquid is taken into consideration additionally, as the determined absorption values depend not only on the refractive index but also on the temperature T of the liquid and the temperature T has effects on the determined absorption values due to its impact on the density of the liquid and the measuring set-up itself, e.g. by changing the beam intensity of the source. The effects of the temperature T on the differential value AD_{CO2} are considered in the first approximation in a linear fashion. It is assumed that the differential value AD_{CO2} is dependent on two mutually independent terms f_{T}(T), f_{CO2}(c_{CO2}) as a sum.

Here, a few model parameters k₀, k_{T}_{_{—}}₁, k_{CO2}_{_{—}}₁ are given, allowing the model function M to be adapted to the actually measured values. By conversion, the following is obtained for the CO₂ concentration c_{CO2} by measuring temperature T and the first differential value AD_{CO2}:

$${c}_{CO 2 , uncorr} = \frac{{AD}_{CO 2} - {k}_{0} - {k}_{T \_ 1} \cdot T}{{k}_{CO 2 \_ 1}}$$

This result does not take the influences of refractive index n on the first differential value AD_{CO2} and on the first absorption value A_{CO2} into consideration. In order to carry out a consideration, the uncorrected CO₂ concentration c_{CO2,uncorr} can be multiplied by a correction term fₙ(ADn, T), which is polynomially dependent on the second differential value ADₙ and linearly dependent on temperature:

fₙ(ADₙ,T)=A′+B′·T+C′·ADₙ+D′·ADₙ²+E′·ADₙ³

By inserting the correction term f_{corr}(ADₙ, T) into

c_{CO2}=M(AD_{CO2},ADₙ,T)=c_{CO2,uncorr}·fₙ(ADₙ,T)

the following connection is obtained:

M(AD_{CO2},ADₙT)=c_{CO2,corr}==c_{CO2,uncorr}·(A′+B′·T+C′·ADₙ+D′·ADₙ²+E′·ADₙ³+ . . . )

In case of a polynomial development of the correction term at a degree of three, this model has a total of eight model parameters, which are: A′, B′, C′, D′, E′ as well as k₀, k_{T}_{_{—}}₁, k_{CO2}_{_{—}}₁ in this example.

For determining the model parameter, a number of m measurements of temperature T as well as the absorption values A_{ref}, Aₙ, A_{CO2} of various known liquids with known CO₂ concentrations and mutually different extract concentrations or refractive indices is carried out each at different temperatures. Model parameters, for which the model function matches the known CO₂ concentrations as well as possible, are determined using a fitting method based on the determined measurement values I, A_{ref}, Aₙ, A_{CO2}.

As an alternative to a fitting method, the individual model parameters can of course be solved analytically based on the individual measured values as well as the known CO₂ concentrations c_{CO2,1}, c_{CO2,2}, . . . c_{CO2,m}.

M(T₁,A_{ref,1},A_{n,1},A_{CO2,1})=c_{CO2,1}

M(T₂,A_{ref,2},A_{n,2},A_{CO2,2})=c_{CO2,2}

M(Tₘ,A_{ref,m},A_{n,m},A_{CO2,m})=c_{CO2,m}

A second exemplary embodiment of the invention takes into consideration the changing penetration depth dₚ of the measuring beam into the liquid to be tested, which results from the different refractive indices of said liquid to be tested. These influences are now considered by introducing the second differential value ADₙ=Aₙ−A_{ref}. Looking at the basic connections indicated for the CO₂ measurement, between concentration c, penetration depth dₚ and/or the evaluated length of path of the evanescent field and the first differential value AD_{CO2}, then approximately,

AD_{CO2}=ε·c_{CO2}·dₚ

wherein ε is the transmissivity for radiation at a measurement wavelength λ_{CO2} of each liquid. For an individual measurement with reflection element 11 and a defined beam geometry at a given wavelength λ, this results in a simple connection between refractive index and penetration depth dₚ.

In the third wavelength range λₙ between 3300 nm and 3900 nm, the absorption ranges of ethanol (alcohol) and various sugar types overlap in aqueous solution. These influences are taken into consideration by measuring the third absorption value Aₙ at λₙ and determining a second differential value ADₙ between the third and second absorption values: ADₙ=Aₙ−A_{ref}. For the second differential value ADₙ, the below approximate assumption is made, in which the temperature dependency of the measurement signal is taken into consideration, resulting in the following connection:

ADₙ=ƒ_{T}(T)+ƒₑₓ(c_{extract})=·j₀+j_{T}_{_{—}}₁·T+jₙ_{_{—}}₁·c_{extract}

in which c_{extract} indicates the concentration of extracts dissolved in each liquid, such as sugar or alcohols, which contribute to a change of the refractive index of the respective liquid to be tested. Also, model parameters j₀, j_{T}_{_{—}}₁jₙ_{_{—}}₁ are given again, allowing the respective functions f to be adapted to the actually measured values. If this relation is converted in favour of c_{extract}, the following connection is obtained:

$${c}_{extract} = \frac{{AD}_{n} - {j}_{0} - {j}_{T \_ 1} \cdot T}{{j}_{n - 1}}$$

The extract concentration c_{extract} that can thereby be determined is a direct measure for the refractive index of the solution and therefore the penetration depth of the measuring beam into the solution. The extract concentration c_{extract} is thus available as a corrective factor for determining the CO₂ concentration. However, the extract concentration c_{extract} can no longer be taken into consideration in a strictly linear fashion according to the Beer-Lambert law, as this connection applies only approximately for the absorption by a single defining component in the extract only. Yet, as in real life a mixture or composition of several extract components and/or alcohol is present, the mixture is no longer a ternary mixture of agents, so the physical proportions can only be represented approximately.

The refractive index is defined as the relation between the propagation rate of light in vacuum c and the speed of light in liquid v and is directly dependent on the extract concentration of the liquid to be tested, and this behaviour is, among others, used for determining the sugar concentrations in solutions using refractometers. In addition, the refractive index of the mixture of agents is not analytically available based on the mere measurement of a single wavelength due to other dependencies (molar mass, polarisability). The absorption values measured within the first wavelength range between 3300 nm and 3900 nm, however, are representative for the respective extract and alcohol concentrations.

The penetration depth dₚ will now be modelled in such a way that, depending on the desired accuracy, the penetration depth dₚ and the refractive index n from absorption ADₙ will be considered for further observation with several members and calibration constants. For this correction, for example, a multi-membered polynomial approach or an exponential approach could be used to correct the measured CO₂ concentration for the measured extract absorption.

If, for example, a polynomial approach is used for the penetration depth dₚ, then:

dₚ=A+B·T+C·ADₙ+D·ADₙ²+E·ADₙ³+ . . .

For the dependency of the measured absorption AD_{CO2} of any given CO₂ concentration on the penetration depth dₚ, this means:

AD_{CO2}=ε·c_{CO2}·dₚ=ε·c_{CO2}·(A+B·T+C·ADₙ+D·ADₙ²+E·ADₙ³+ . . . )

When this equation is converted in favour of c_{CO2}, the following is obtained:

$${c}_{CO 2} = M ( {AD}_{CO 2} , {AD}_{n} , T ) = \frac{{AD}_{CO 2}}{ɛ \cdot ( A + B \cdot T + C \cdot {AD}_{n} + D \cdot {AD}_{n}^{2} + E \cdot {AD}_{n}^{3} + … )} .$$

A third exemplary embodiment of a model function M takes into consideration measurement methods in which the first absorption value AD_{CO2} has not been determined at a specific wavelength but as an integrally measured absorption value over a certain wavelength range of about 50 nm to 100 nm.

If filters with greater spectral width are chosen for increasing the intensities while at the same time using construction members that are as inexpensive as possible, the basic linear connection between concentration and intensity of CO₂ absorption as presented by the Beer-Lambert law does no longer apply. Instead, this connection can better be approximated by an exponential dependency, if instead of absorption intensity at a single wavelength blanked out from the spectrum the tsansmissivity of the filters used, and thus also the integrally measured absorption, are measured over a certain wavelength range of about 50 nm to 100 nm. This means that at a 40 nm half-width of the CO₂ absorption peak the transmissive spectral wavelength range of the filter is wider than or equal to the actual width of the CO₂ absorption peak.

AD_{CO2}=ƒ(c_{CO2})=A_{CO2}−A_{Ref}=k_{CO2}_{_{—}}₀*+k_{CO2}_{_{—}}₁*·exp(k_{CO2}_{_{—}}₂*·c_{CO2})

or, when including the temperature:

$${AD}_{CO 2} = {f}_{T} ( T ) + f ( {c}_{CO 2} ) = {k}_{0}^{*} + {k}_{T \_ 1}^{*} \cdot T + {k}_{CO 2 \_ 1}^{*} \cdot exp ( {k}_{CO 2 \_ 2}^{*} \cdot {c}_{CO 2} )$$

$${c}_{CO 2 , uncorr} = {c}_{CO 2} = \frac{1}{{k}_{CO 2 \_ 2}^{*}} ln ( \frac{{AD}_{CO 2} - {k}_{0}^{*} - {k}_{T \_ 1}^{*} \cdot T}{{k}_{CO 2 \_ 1}^{*}} )$$

If the refractive index correction is carried out in analogy to the second exemplary embodiment, then the following is obtained:

M(AD_{CO2},ADₙT)=c_{CO2corr}==c_{CO2}_{_{uncorr}}·(A″+B″·T+C″·ADₙ+D″·ADₙ²+E″·ADₙ³+ . . . )

A fourth exemplary embodiment of a model function M takes into consideration that the individual equations for refractive index, temperature and measured intensities cannot be looked at independently in CO₂ absorption. The refractive index shows dispersive behaviour that depends on each respective liquid to be tested, also the extinction coefficient changes in the equation along with the wavelength and the temperature T. In order to avoid the requirement of carrying out complex analytical evaluations of the individual equations the following simplified approach can be applied:

Based on an empirical curve fit for the CO₂ concentration, the temperature T and the refractive index, i.e. also the penetration depth of the measuring beam, are taken into consideration in a model formation by varying the constant according to the model.

For the exponential approach, this means that:

$${AD}_{CO 2} = {Y}_{0} + {A}_{1} \cdot exp ( - \frac{{c}_{CO 2}}{{t}_{1}} )$$

Now the dependency of the temperature T and the refractive index in the individual terms Y₀, A₁ and t₁ will each be taken into consideration below by a linear approach for the temperature T and a polynomial approach for the refractive index, i.e. for the measured absorption:

Y₀=A_{nY0}+B_{nY0}·ADₙ+C_{nY0}·ADₙ²+A_{TY0}+B_{TY0}·T=A_{Y0}+B_{nY0}·ADₙ+C_{nY0}·ADₙ²+B_{TY0}·T

Y₀=A_{nA1}+B_{nA1}·ADₙ+C_{nA1}·ADₙ²+A_{TA1}+B_{TA1}·T=A_{A1}+B_{nA1}·ADₙ+C_{nA1}·ADₙ²+B_{TA1}·T

Y₀=Aₙₜ₁+Bₙₜ₁·ADₙ+Cₙₜ₁·ADₙ²+A_{Tt1}+B_{Tt1}·T=Aₜ₁+Bₙₜ₁·ADₙ+Cₙₜ₁·ADₙ²+B_{Tt1}·T

If the above equation is converted, the following expression is obtained as model function M:

$$M ( {AD}_{CO 2} , {AD}_{n} , T ) = {c}_{CO 2} = - {t}_{1} \cdot ln ( \frac{{AD}_{CO 2} - {Y}_{0}}{{A}_{1}} )$$

By using a linear approach for the temperature T and a polynomial approach for the refractive index and thus for the measured absorption, the following connection is obtained for model function M:

$${c}_{CO 2} = - ( \begin{matrix}{A}_{t 1} + {B}_{nt 1} \cdot {AD}_{n} + \\ {C}_{nt 1} \cdot {AD}_{n}^{2} + {B}_{Tt 1} \cdot T\end{matrix} ) ln ( \frac{{AD}_{CO 2} - ( \begin{matrix}{A}_{Y 0} + {B}_{nY 0} \cdot {AD}_{n} + \\ {C}_{nY 0} \cdot {AD}_{n}^{2} + {B}_{TY 0} \cdot T\end{matrix} )}{{A}_{A 1} + {B}_{nA 1} \cdot {AD}_{n} + {C}_{nA 1} \cdot {AD}_{n}^{2} + {B}_{TA 1} \cdot T} ) ,$$

in which the factors A_{Y0}, A_{A1}, Aₜ₁, B_{nY0}, B_{nA1}, Bₙₜ₁, C_{nY0}, C_{nA1}, Cₙₜ₁, B_{TY0}, B_{TA1}, B_{Tt1} appear as model parameters.

Determination of the model parameters, as in the other exemplary embodiments of the invention, is done by calibration based on known measurement values. A number of m measurements of temperature T and the absorption values A_{ref}, Aₙ, A_{CO2} of various known liquids with known CO₂ concentrations and mutually different extract concentrations or refractive indices is carried out each at different temperatures. Model parameters, for which the model function matches the known CO₂ concentrations as well as possible, are determined using a fitting method based on the determined measurement values I, A_{ref}, Aₙ, A_{CO2}. A system of equations, which has one equation for each separate measurement, is created.

M(T₁,A_{ref,1},A_{n,1},A_{CO2,1})=c_{CO2,1}

M(T₂,A_{ref,2},A_{n,2},A_{CO2,2})=c_{CO2,2}

M(Tₘ,A_{ref,m},A_{n,m},A_{CO2,m})=c_{CO2,m}

This system of equations is solved approximately. In particular, a more accurate result can be obtained by increasing the number of measurements. In the present case, 12 model parameters need to be determined, hence at least 12 equations have to be set up. In the present case, 18 measurements are performed, wherein each temperature T, each refractive index and each previously-known CO₂ content are indicated in Table 2.

| T | C_{CO2} | C_{extract} |
|---|---|---|
| [° C.] | [g/l] | [BRIX] |
| 0 ÷ 5 | 1 ÷ 2 | 0 |
| 0 ÷ 5 | 5.5 ÷ 6.5 | 0 |
| 0 ÷ 5 | 10 ÷ 11 | 0 |
| 20 ÷ 25 | 1 ÷ 2 | 0 |
| 20 ÷ 25 | 5.5 ÷ 6.5 | 0 |
| 20 ÷ 25 | 10 ÷ 11 | 0 |
| 0 ÷ 5 | 1 ÷ 2 | 6 ÷ 7 |
| 0 ÷ 5 | 5.5 ÷ 6.5 | 6 ÷ 7 |
| 0 ÷ 5 | 10 ÷ 11 | 6 ÷ 7 |
| 20 ÷ 25 | 1 ÷ 2 | 6 ÷ 7 |
| 20 ÷ 25 | 5.5 ÷ 6.5 | 6 ÷ 7 |
| 20 ÷ 25 | 10 ÷ 11 | 6 ÷ 7 |
| 0 ÷ 5 | 1 ÷ 2 | 14 ÷ 15 |
| 0 ÷ 5 | 5.5 ÷ 6.5 | 14 ÷ 15 |
| 0 ÷ 5 | 10 ÷ 11 | 14 ÷ 15 |
| 20 ÷ 25 | 1 ÷ 2 | 14 ÷ 15 |
| 20 ÷ 25 | 5 ÷ 6 | 14 ÷ 15 |
| 20 ÷ 25 | 9 ÷ 10 | 14 ÷ 15 |

Table 2 shows a practical example for the measurement of constants using a prototype of the sensor head. The following conditions have to be set for measuring:

During calibration, at least 3 different CO₂ concentrations at a minimum of 2 different temperatures and at least 3 different sugar concentrations (and thus refractive indices n) are measured. This results in the 12 model parameters for the selected analytical approach.

This evaluation of the conducted calibration measurements for the known CO₂ concentrations results in the following constants:

A_{y0}=−0.01983,B_{ny0}=−6.4902,C_{ny0}=−28.04101,B_{Ty0}=−0.00245

A_{A1}=0.09595,B_{nA1}=4.72755,C_{nA1}=20.50155,B_{TA1}=0.00224

Aₜ₁=14.83044,Bₙₜ₁=26.58616,Cₙₜ₁=679.05946,B_{Tt1}=−0.30869

The actual concentration calculation is then based on the differential values ADₙ and AD_{CO2} and the temperature T, and if the indicated model parameters are used, the CO₂ values measured with the inventive embodiment are in excellent accord with comparative measurements.

In all model functions, the dependency on temperature can be neglected by fixing a predefined temperature a given liquid typically has when the absorption values are measured. Determination of the model parameters can then also take place when liquids of a single temperature, which is preferably equal to the fixed temperature, are used. These liquids then need to be different only in CO₂ content and in extract content c_{extract}.

1-13. (canceled)

14. A method for determining a CO₂ content in a liquid, the method which comprises:
carrying out an absorption measurement of the liquid to be measured at a minimum of one wavelength within a first wavelength range between 4200 and 4300 nm and measuring a first absorption value using the method of attenuated total reflectance;
carrying out an absorption measurement of the liquid to be measured at a minimum of one second wavelength within a second wavelength range between 3950 and 4050 nm and measuring a second absorption value using the method of attenuated total reflectance;
carrying out an absorption measurement of the liquid to be measured additionally at a minimum of one third wavelength within a third wavelength range between 3300 and 3900 nm and measuring a third absorption value using the method of attenuated total reflectance;
using a pre-defined model function for determining the CO₂ content based on the first, second and third absorption values; and
applying the model function to the determined first, second and third absorption values and keeping a result of the evaluation available as the CO₂ content of the liquid to be tested.

15. The method according to claim 14, wherein at least one of the following applies:
a measurement of the first absorption value by determining the absorbed intensity is performed in a first measurement area, which is defined by a first spectral centroid within the first wavelength range and a first area width 2Δλ_{CO2}, in which the first measurement area is in the range of λ_{S,CO2}±Δλ_{CO2}, and/or
a measurement of the second absorption value by determining the absorbed intensity is performed in a second measurement area, which is defined by a second spectral centroid within the second wavelength range and a second area width 2Δλ_{ref}, in which the second measurement area is in the range of λ_{S,ref}±Δλ_{ref}, and/or
a measurement of the third absorption value by determining the absorbed intensity is performed in a third measurement area, which is defined by a third spectral centroid within the third wavelength range and a third area width 2Δλₙ, in which the third measurement area is in the range of λ_{S,n}±Δλₙ,
wherein at least one of the first area width, the second area width, or the third area width each lies within a range between 20 nm and 200 nm.

16. The method according to claim 15, which comprises setting at least one of the first area width, the second area width, or the third area width to lie at substantially 100 nm.

17. The method according to claim 14, which comprises:
determining the first absorption value at a predefined wavelength within the first wavelength range; and/or
determining the second absorption value at a predefined wavelength within the second wavelength range; and/or
determining the third absorption value at a predefined wavelength within the third wavelength range.

18. The method according to claim 17, which comprises:
determining the first absorption value exclusively at 4260 nm; and/or
determining the second absorption value exclusively at 4020 nm; and/or
determining the third absorption value exclusively at 3800 nm.

19. The method according to claim 14, which comprises determining a temperature of the liquid to be tested in addition to determining the first, second and third absorption values, and wherein:
the model function for determining the CO₂ content takes the temperature of the liquid to be tested into consideration in addition to the first, second and third absorption values; and
the model function is applied to the first, second and third determined absorption values and also to the determined temperature and the result of the evaluation is kept available as the CO₂ content of the liquid to be tested.

20. The method according to claim 14, which comprises, prior to determining the CO₂ content, creating a model function and keeping same available for determining the CO₂ content by
conducting a plurality of reference measurements of the first, second and third absorption values each for different reference liquids with known CO₂ contents and different refractive indices,
creating the model function having the following formula:
M=M(A_{CO2},A_{ref},Aₙ, . . . ,B₁, . . . ,B_{N})
using a fitting method, in which previously unknown model parameters are each adjusted to the given CO₂ content and to the first, second and third absorption values, so that the known CO₂ content is obtained, or at least approximated, when the model function is applied to the first, second and third absorption values.

21. The method according to claim 20, which comprises, in addition to the first, second and third absorption values, determining a temperature of each respective reference liquid in the plurality of reference measurements, and creating the model function having the following formula:
M=M(A_{CO2},A_{ref},Aₙ,T,C₁, . . . ,C_{N})
using a fitting method in which previously unknown model parameters are each adjusted to the given CO₂ content, to the measured first, second and third absorption values and to the respective temperature, thus obtaining the known CO₂ content, or at least approximating same, when the model function is applied to the first, second and third absorption values as well as the temperature.

22. A device for determining the CO₂ content in a liquid to be tested, the device comprising:
a first ATR measurement unit for determining a first absorption value at a first wavelength within a first wavelength range between 4200 and 4300 nm;
a second ATR measurement unit for determining a second absorption value at a second wavelength within a second wavelength range between 3950 and 4050 nm;
a third ATR measurement unit for determining a third absorption value at a third wavelength within a third wavelength range between 3300 and 3900 nm; and
an evaluation unit connected to receive from said first, second, and third ATR measurement units respective measurement results, said evaluation unit being configured to apply a model function to the first, second and third absorption values, and wherein a result of the evaluation is kept available at an output of said evaluation unit as the CO₂ content of the liquid to be tested.

23. The device according to claim 22, wherein:
said first, second and third ATR measurement units for determining the absorbed intensity are sensitive in a first, a second and a third measurement area, respectively;
a first measurement range is defined by a first spectral centroid within the first wavelength range and a first area width 2Δλ_{CO2} and the first measurement area is determined to be in the range of λ_{S,CO2}±Δλ_{CO2}, and/or
a second measurement area is defined by a second spectral centroid within the second wavelength range and a second area width 2Δλ_{ref} and the second measurement area is determined to be in the range of λ_{S,ref}±Δλ_{ref}, and/or
a third measurement area is defined by a third spectral centroid within the third wavelength range and a third area width 2Δλₙ and the third measurement area is determined to be in the range of λ_{S,n}±Δλₙ, and
the first and/or second and/or third area widths are each within a range between 20 nm and 200 nm.

24. The device according to claim 23, wherein the first and/or second and/or third area widths are substantially 100 nm.

25. The device according to claim 22, which further comprises a temperature sensor upstream of said evaluation unit for determining a temperature of the liquid to be tested, wherein said evaluation unit is configured to apply a model function to the first, second and third absorption values and the temperature determined by the temperature sensor and to keep a result of the evaluation available at said output as the CO₂ content of the liquid to be tested.

26. The device according to claim 25, which further comprises a container for storing or conveying the liquid to be tested, wherein sensitive surface parts of said ATR measurement units, and optionally said temperature sensor, come into contact with the liquid to be tested when the liquid is filled into, or passes through, said container.

27. The device according to claim 26, wherein said sensitive surface parts of said ATR measurement units and of said temperature sensor are arranged on an inside of said container.

28. The device according to claim 22, which comprises:
a memory for storing predefined coefficients in said evaluation unit; and
wherein said evaluation unit has a calculation unit configured to receive the stored coefficients and also the first, second and third absorption values, and optionally also the determined temperature, and to evaluate the model function based on the values so received with to keep available at the outlet of the evaluation unit.

29. The device according to claim 22, wherein one of the following is true:
each said ATR measurement unit comprises an ATR reflection element, an ATR infrared source and an ATR infrared sensor; or
all of said ATR measurement units share a mutual ATR reflection element and a mutual ATR infrared source active within the first, second and third wavelength ranges and also a mutual ATR infrared sensor active within the first, second and third wavelength ranges, wherein an adjustable filter is disposed in an optical path between said ATR infrared source and said ATR infrared sensor, and said adjustable filter, depending on a setup thereof, is transmissive only for radiation within the first, the second or the third wavelength range; or
said ATR measurement units share a mutual ATR reflection element and a mutual ATR infrared source active within the first, second and third wavelength ranges and separate ATR infrared sensors are provided for the first, second and third wavelength ranges, each located at a end of a respective optical path; or
said ATR measurement units share a mutual ATR reflection element and a mutual ATR infrared sensor for all wavelength ranges and separate ATR infrared sources are provided for the first, second and third wavelength ranges.

30. The device according to claim 29, wherein said adjustable filter comprises a filter wheel or a Fabry-Perot interferometer.

31. The device according to claim 22, wherein said ATR measurement units have at least two separate ATR infrared sources and corresponding ATR infrared sensors each with independent optical paths and different sensitivities for two measurement ranges, wherein it is always one measurement unit of the first infra-red sensor and one measurement unit of the second infra-red sensor that are sensitive for the same wavelength range, and wherein a referencing unit is provided and configured to multiply the measurement value of the third measurement unit by the ratio between the measurement values of the two measurement units sensitive for the same wavelength range, keeping it available at an output thereof.
